(19) United States
(12) Patent Application Publication
(10) Pub. No.: US 2007/0189292 A1
(43) Pub. Date: Aug. 16, 2007

(54) Bandwidth Estimation of an Underlying Connection-Oriented Transport Connection From Higher Layers

(75) Inventors: Ajay Kumar Singh, New Delhi (IN); Partha Venkata Kanuparthy, Hyderabad (IN)

Correspondence Address: LAW FIRM OF NAREN THAPPETA, 158, PHASE ONE PALM MEADOWS, RAMAGUNDANAHALLI, AIRPORT WHITEFIELD ROAD, BANGALORE, 560043, IN

(73) Assignee: ORACLE INTERNATIONAL CORPORATION, Redwood Shores (US)

(21) Appl. No.: 11/308,536

(22) Filed: Apr. 4, 2006

(30) Foreign Application Priority Data
Feb. 15, 2006 (IN) 251/CHE/2006

(51) Int. Cl. H04L 12/56

(52) U.S. Cl. 370/392; 370/401

(57) ABSTRACT

Estimating bandwidth of a transport connection from higher layers. In an embodiment, the bandwidth is estimated as a function of the window size, the time taken to transfer a transport payload of window size from the sender system to the receiver system, and a conclusion indicating whether the window size is limited by the network or by the resources on the receiver system. All the factors used in the bandwidth computation are determined based on round-trip times of transport payloads of different sizes transferred between the sender system and the receiver system.

### RELATED APPLICATIONS

The present application is related to and claims priority from the co-pending India Patent Application entitled, “Bandwidth Estimation of an Underlying Connection-Oriented Transport Connection From Higher Layers”, Serial Number: 251/CHE/2006, Filed: 15 Feb. 2006, naming the same inventors as in the subject patent application.

### BACKGROUND OF THE INVENTION

1. Field of the Invention

The present invention relates to networking technologies, and more specifically to a method and apparatus to estimate the window size of an underlying transport (e.g., TCP) connection from higher layers and to estimate bandwidth of the underlying transport connection using the estimated window size.

2. Related Art

A connection-oriented transport (e.g., TCP) connection provides reliable transfer of a sequence of bytes from a sender system to a receiver system. In general, higher-level layers (e.g., application layers) at the sender system provide the desired data to be transferred to the TCP connection, and the TCP connection interfaces with lower layer protocols (e.g., Internet protocol) to transfer a sequence of data (containing the desired data), potentially in the form of packets.

At least in Internet Protocol (IP) based network environments, the TCP connection splits the sequence of data desired to be transferred into successive packets, and each packet is sent using IP. The receiver system sends acknowledgement packets indicating the receipt of the data. In Transmission Connection Protocol (TCP) type transport environments, a sequence number is associated with each corresponding packet of the data being transferred, and the acknowledgment indicates the sequence number up to which all the corresponding bytes of the data are successfully received.

Connection-oriented transport connections (hereafter “transport connections”) are characterized by windows. For example, the TCP transport layer maintains windows at the sender and the receiver endpoints. The sender window specifies the amount of data (in terms of a number of bytes) that a sender system can send unilaterally, but needs to wait for an acknowledgement (for any of the packets already sent) before sending additional data beyond the window size. The receiver window specifies the amount of data the receiving side can buffer before the corresponding higher layers (e.g. the application layer) picks them up. The receiver window can thus set an upper limit on the sender window size.

There is often a need to determine the window size of transport connections. Particular challenges are presented in TCP based environments since TCP (in one prior embodiment) continually adjusts the sender window size during the lifetime of a connection, according to the network conditions and the receiver side conditions. Initially TCP sets its sender window size to the lower of the maximum TCP packet size and the receiver's window size. After initialization, TCP operates in the ‘slow-start’ phase where it doubles the sender window size for every successful transmission, until the window size reaches the receiver window size, or until it sees a network loss. At this point, the TCP sender window size is limited either by the receiver (the former case) or the network (the latter case). In the former case, the sender window size is kept constant, and equals the receiver window size. In the latter case, TCP increases the sender window size by one segment (a transport payload) for every successful transmission of a window's worth of data, and halves the window size upon a loss in the network. We observe that the throughput of a TCP connection is a direct function of the window size, and the duration of a round-trip (RTT).

There is also a need to determine the peak throughput that a transport connection can attain from higher layers. Estimates of TCP bandwidth can be used for several purposes, for example, to control the amount of data a higher-level application generates. As an illustration, a user application generating video frames for transmission on a network may curtail the number of frames generated per second, the resolution (number of pixels) of the video content, or the depth (number of bits per pixel) of each frame if sufficient bandwidth is deemed to be unattainable. Estimating the window size of the underlying TCP connection is one useful way of estimating the throughput of the TCP connection, as is clear from the discussion above of TCP window behavioral dynamics.

Several prior approaches exist for estimating the bandwidth of the underlying transport connection. In one prior approach implemented in the TCP context, a fixed amount of data of pre-determined size (irrespective of the underlying network's characteristics) is injected into the TCP connection to determine the bandwidth. One disadvantage with such an approach is that accurate measurement would not be possible if the pre-determined size is small in the case of underlying networks with large available capacity, and could lead to unacceptably high waiting time and/or traffic overhead on the network in the case of underlying networks with low available capacity. This approach is used in the IPerf network-monitoring tool, well known in the relevant arts.

What is therefore needed is an approach, which enables the bandwidth of a transport connection to be determined while addressing one or more problems/requirements described above.

### BRIEF DESCRIPTION OF THE DRAWINGS

The present invention will be described with reference to the accompanying drawings briefly described below.

FIG. 1 is a block diagram of an example environment in which various aspects of the present invention can be implemented.

FIG. 2 is a flowchart illustrating the manner in which the bandwidth of an underlying transport connection is estimated according to an aspect of the present invention.

FIG. 3 is a flowchart illustrating the manner in which the bandwidth of an underlying transport connection is computed from the times taken to transfer packets according to an aspect of the present invention.

FIG. 4 is a flowchart illustrating the manner in which the boundaries for estimating the window size of an underlying transport connection is computed according to an aspect of the present invention.

FIG. 5 is a flowchart illustrating the manner in which the cause of the limitation of the bandwidth of the underlying transport connection is determined according to an aspect of the present invention.

FIG. 6 is a block diagram illustrating an example embodiment in which various aspects of the present invention are operative when software instructions are executed.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

### 1. Overview

An aspect of the present invention determines the window size of an underlying transport connection based on the transfer times (duration of time to transfer a payload) of transport payloads of different sizes. The determination is based on the recognition that when the size of a transport payload is less than or equal to a multiple of the window size and the size of a second transport payload is greater than this multiple of the window size, the transfer time of the second transport payload would be more than the first by at least one transfer time for a small payload (in case of TCP, a size less than the maximum size of one TCP segment). The transfer time for a small payload (as defined above) is defined as the ‘network round-trip time’ (RTT).

Another aspect of the present invention determines whether the limitation of the determined window size (and thereby the bandwidth, as described below) is due to the underlying network or due to the resources in the receiver, again based on the transfer times. The determination is performed by sending transport payloads of multiple times the determined window size, and concluding that the window size is limited by the network if the transfer time exceeds the same multiple of the transfer time for the determined window size, or by the resources in the receiver system otherwise.

One more aspect of the present invention computes the bandwidth of the underlying transport connection using the transfer times of transport payloads of different sizes. In an embodiment, the determined window size, the network roundtrip time, and the cause of the limitation of the window size, are used to compute the transport bandwidth.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Example Environment

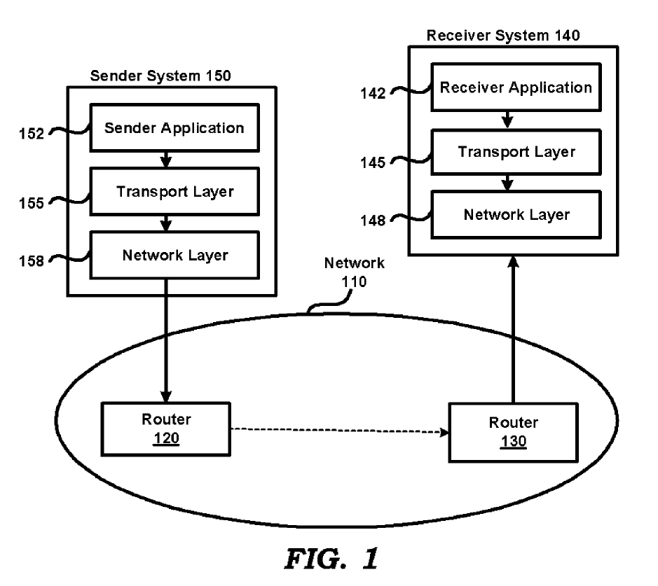

FIG. 1 is a block diagram of an example environment in which various aspects of the present invention can be implemented. The environment is shown containing network 110 formed from routers 120 and 130, sender system 150 (containing sender application 152, transport layer 155 and network layer 158), receiver system 140 (containing receiver application 142, transport layer 145, and network layer 148). Each of the components of FIG. 1 is described in detail below.

Network 110 contains routers 120 and 130, which forward packets generally according to a network protocol. For example, in the case of IP, each packet is forwarded based on the destination address contained in the packet. The packets thus forwarded are used to setup TCP connections (example of transport connections) and then exchange data between applications executing on sender system 150 and receiver system 140. The window size and bandwidth of the TCP connections are estimated according to various aspects of the present invention, as described below in further detail.

Sender application 152 generates large amounts of data, which need to be sent to receiver application 142 through network 110. To facilitate such transfers, sender application 152 may request a TCP connection by interfacing with transport layer 155, and receive indication of completion of setup of the connection. Sender application 152 provides segments of data (“transport payloads”) to the underlying transport layer 155 for transfer on the setup connections.

In an embodiment, sender application 152 estimates the bandwidth of the TCP connection, and sends transport payloads with magnitude of data corresponding to the indicated bandwidth. For example, if the bandwidth is very high, in case of video applications noted in the background section above, the sender applications may send more data (e.g., more frames/resolution/depth) to receiver application 142.

Transport layer 155 divides each transport payload received from sender application 152 into smaller portions if necessary, and interfaces with network layer 158 to forward each portion of the data in a corresponding packet. Each packet generally contains additional information (based on a common protocol like Transmission Control Protocol (TCP)) such as port numbers associating the packet to the TCP connection (and thus the applications at either end) about the data being sent. Transport layer 155 may use a buffer (not shown) for temporarily storing each transport payload received from sender application 152, and the data may be removed once receiver system 140 acknowledges receipt of the entire data.

Network layer 158 receives each portion of data from transport layer 155, packages the data in the form of a network packet, and sends the packet to receiver system 140 on network 110. Network layer 148 receives packets of data from sender system 150 on network 110, and forwards the data contained in the packets to transport layer 145. Transport layer 145 sequences the data in the received packets, and sends acknowledgments confirming receipt of the data to sender system 150. Transport layer 145 may also contain a buffer for temporarily storing and sequencing the received data, before passing the data bytes as a stream to receiver application 142.

It may be appreciated that the peak throughput (e.g., bulk transfer capacity) that sender application 152 can attain using the transport layer 155 in the network 110 is dependent on the window size in transport layer 155 of sender system 150. Sender application 152 may estimate the window size of transport layer 155 to estimate the bandwidth of network 110. The estimation of the bandwidth of the TCP connection from higher layers is described in detail below.

### 3. Estimating Bandwidth

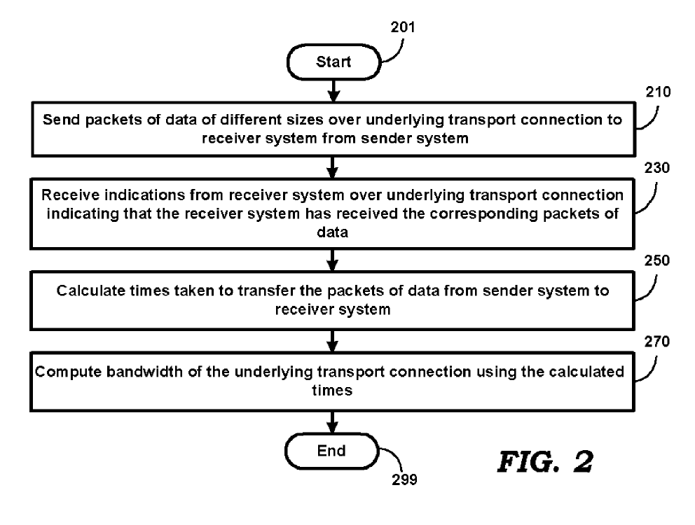

FIG. 2 is a flowchart illustrating the manner in which the bandwidth of an underlying transport connection is estimated according to an aspect of the present invention. The flowchart is described with respect to the systems of FIG. 1 merely for illustration. However, the features can be implemented in various other environments without departing from the scope and spirit of the present invention. The flowchart begins in step 201, in which control passes to step 210.

In step 210, sender application 152 in sender system 150 sends transport payloads in a sequential manner of different sizes over underlying transport layer 155 to receiver system 140. By ‘sequential’, we mean that the sender application sends a new payload only after receiving an indication from the receiver system 140 that the receiver system 140 has received the old payload. Since the transfer times are sought to be determined for the transport payloads (as described below), sender application 152 (and the receiver system 142) may instruct transport layer 155 (and the transport layer 145 respectively) (e.g., using NODELAY socket option in case of TCP protocol) to send the data immediately (without waiting for window/buffer size of data to be received) to receiver system 140.

In step 230, sender application 152 receives an indication from the receiver system 140 indicating that receiver system 140 has received a transport payload. Various approaches can be used in generating such indications. In an embodiment, receiver application 142 is implemented to cooperatively send receipt confirmation upon completion of receipt of each transport payload.

In step 250, sender application 152 calculates the transfer time taken to transfer a transport payload from sender system 150 to receiver system 140. In an embodiment, the transfer time is measured as round-trip time, that is, the time between sending a transport payload from sender system 150 and receiving an acknowledgement confirming receipt of the entire payload from receiver system 140. The sender application 152 sends the next transport payload, described in step 210, of a different size, after receiving the acknowledgement and calculating the transfer time.

In step 270, sender application 152 computes the bandwidth of underlying transport layer 155 using the transfer times found in step 250. The bandwidth can be computed from the transfer times using one of various approaches, as will be apparent to one skilled in the relevant arts. An example approach is described below in further detail. The flowchart ends in step 299.

### 4. Computing Bandwidth Using Transfer Time

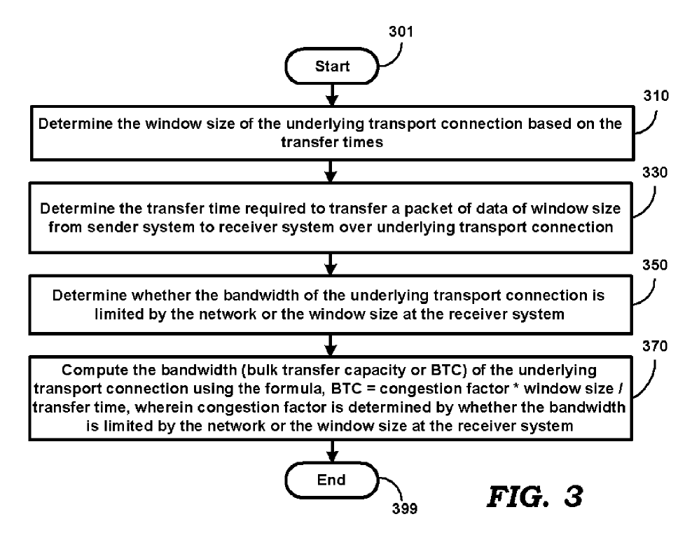

FIG. 3 is a flowchart illustrating the manner in which the bandwidth of an underlying TCP connection is computed from the transfer times according to an aspect of the present invention. The flowchart begins in step 301, in which control passes to step 310.

In step 310, sender application 152 determines the window size of the underlying TCP connection based on the transfer times calculated in step 250. The determination is based on the recognition that when the size of a transport payload is less than (or equal to) a multiple of the window size and the size of a second transport payload is greater than the multiple of the window size, the transfer time of the second transport payload would be more than the first by one transfer time for a payload of size less than or equal to the maximum packet size (the maximum segment size in case of TCP).

In step 330, sender application 152 determines the transfer time required to transfer a small transport payload of window size from sender system 150 to receiver system 140 on network 110. The information on the round-trip times of step 310 can be used for such a determination once the window size is determined. Alternatively, the round-trip time corresponding to transferring a very small transport payload (smaller than the maximum segment size in case of TCP) can be used as an approximation.

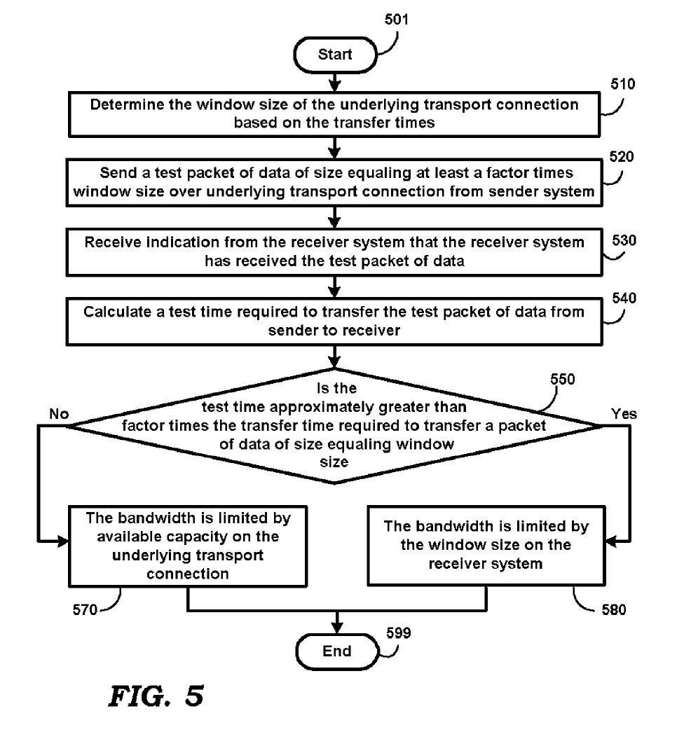

In step 350, sender application 152 determines whether the bandwidth of the underlying TCP connection is limited by network 110 (or specifically, the path taken on network 110) or the buffer size at receiver system 140. As may be appreciated, the network 110 would be determined to be a bottleneck if packet loss (either due to packet drop by routers/switches/buffering devices, or due to losses in transmission lines) occurred during transfers, otherwise the resources in receiver system 140 may be determined to be the limiting factor. The manner in which such an observation can be used is described below with respect to FIG. 5.

In step 370, sender application 152 computes the bandwidth of the underlying TCP connection. The bandwidth of a network can be defined in various ways. A common definition for the bandwidth for TCP transport is the bulk-transfer capacity (BTC) which can be calculated using the formula, BTC=congestion factor*window size/network round-trip time. The value of congestion factor is determined by whether the bandwidth is limited by network 110 or the buffer size at receiver system 140. In an embodiment, congestion factor is set to 0.75 if the bandwidth is limited by network and to 1 otherwise. The flowchart ends in step 399.

As noted above in step 310, one step for computing the bandwidth of underlying TCP connection from higher layers is the estimation of the window size of the underlying TCP connection. The manner in which the window size is determined in one embodiment is described in detail below.

### 5. Estimating Window Size

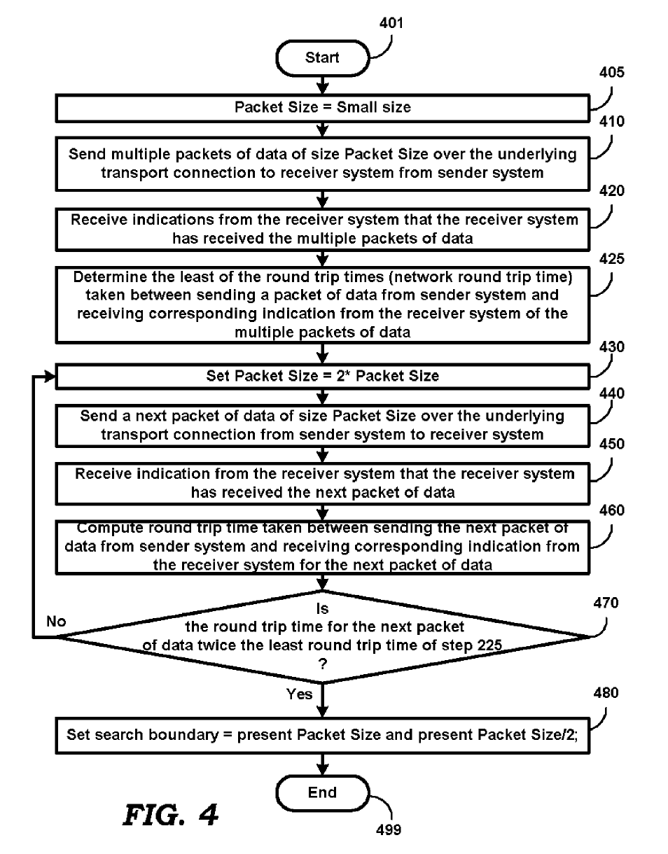

FIG. 4 is a flowchart illustrating the manner in which the boundaries for estimating the window size of an underlying TCP connection are computed according to an aspect of the present invention. The flow chart begins in step 401, in which control passes to step 405.

In step 405, sender application 152 sets the variable “Payload Size” to a small size. In an embodiment, the size is pre-determined based on the structure of network 110 and the transport layer protocol being used for communication between sender system 150 and receiver system 140. The small size is made to be less than the maximum segment size (MSS) of the underlying transport layer between the sender and the receiver systems.

In step 410, sender application 152 sends a transport payload of size “Payload Size” over underlying TCP connection to receiver system 140. In step 420, sender application 152 receives a receipt confirmation that receiver system 140 has received the transport payload. Steps 410-420 are repeated multiple times. In an embodiment, the number of times may be pre-determined based on the structure of network 110.

In step 425, sender application 152 determines the least of the round-trip times taken between sending a payload of data from sender system 150 and receiving corresponding indication from receiver system 140 of the multiple packets of data. We call this transfer time the network round-trip time.

It may be appreciated that steps 410, 420 and 425 are performed based on multiple transport payloads to enable sender application 152 to calculate the transfer time required between sender system 150 and receiver system 140 independent of temporary (transient) changes in network 110.

In step 430, sender application 152 doubles the value of the variable “Payload Size”. In step 440, sender application 152 sends the next payload of data of size “Payload Size” over the underlying TCP connection from sender system 150 to receiver system 140. In step 450, sender application 152 receives receipt confirmation from transport layer 155 that receiver system 140 has received the next payload.

In step 460, sender application 152 computes round-trip time taken between sending the next payload of data from sender system 150 and receiving corresponding receipt confirmation from receiver system 140 for the next payload of data.

In step 470, sender application 152 checks whether the round-trip time for the last payload of data is twice the network round-trip time calculated in step 425. Control passes to step 480 if the round-trip time is at least twice the least round-trip time, or to step 430 otherwise.

In step 480, the search boundary for determining the window size is set to the maximum value of present “Payload Size” and the minimum value to present “Payload Size” divided by 2. A search may be conducted between these boundary values to determine the window size. In an embodiment, a binary search between the boundary values may be conducted to determine the window size with a desired accuracy. Note that over the course of the binary search, the minimum value of the search boundary always has a transfer time of one network round-trip time, and the maximum value of the search boundary has a transfer time of at least two network round-trip times. The searched window size may be set to the average of the search boundary after the binary search terminates.

As noted above, the bandwidth of the underlying TCP connection can be computed from the estimated window size if the cause of limitation of the network can be determined. The determination of whether the bandwidth is limited by the network or the buffer size on the receiver system is described in detail below.

### 6. Estimating the Cause of Limitation of Bandwidth

FIG. 5 is a flowchart illustrating the manner in which the cause of the limitation of the bandwidth of the underlying TCP connection is determined according to an aspect of the present invention. The flow chart begins in step 501, in which control passes to step 510.

In step 510, sender application 152 determines the window size of the underlying TCP connection based on the transfer times between sender system 150 and receiver system 140. Step 510 can be performed similar to the approaches of FIG. 3 described above.

In step 520, sender application 152 sends a test payload of size equaling at least a factor (greater than 1) times the window size over underlying TCP connection from sender system 150. In an embodiment, the factor is chosen as a whole number, for example, 2, making the size of the test payload 2 times the window size.

In step 530, sender application 152 receives receipt confirmation from receiver system 140 that the test payload has been received. In step 540, sender application 152 calculates test time required to transfer the test payload from sender system 150 to receiver system 140.

In step 550, sender application 152 checks whether the test time calculated in step 540 is greater than factor times the transfer time required to transfer a payload of data of small size from sender system 150 to receiver system 140, estimated in step 425. Control passes to step 580 if the test time is greater than the transfer time, or to step 570 otherwise.

In step 570, sender application 152 concludes the cause of limitation of the bandwidth as due to limitations of network 110. This conclusion is based on the observation that packet loss during transfer on network 110 would have resulted in retransfer of packets (due to error recovery mechanism inherent in underlying transport protocols), thereby resulting in the test time being greater than the aforementioned factor times the transfer time.

In step 580, sender application 152 concludes the cause of limitation of the bandwidth as being due to limitation of resources (e.g., buffer size) on receiver system 140. Since there is no loss of packets on network 110, the time required to transfer transport payload of factor times the window size would be equal to factor times the transfer time required for transport payload of one window size. The flowchart ends in step 599.

Thus, it may be appreciated that sender application 152 can compute the bandwidth of the underlying TCP connection using the window size of the underlying TCP connection, the transfer time required to send a payload of data of window size from sender system 150 to receiver system 140 and the cause of limitation of the bandwidth (i.e. whether the bandwidth is limited by the resources of the underlying network, or by the buffer size of the receiver system 140). The bandwidth can be computed at regular intervals (including at the opening of the TCP connection) and the output rate of sender application 152 can be limited/increased consistent with the estimated bandwidth. The bandwidth values can be averaged over time using filters such as the exponential moving average filter to give a more non-temporal measure.

It should be further appreciated that the features described above can be implemented in various embodiments as a desired combination of one or more of hardware, software and firmware. The description is continued with respect to an embodiment in which various features are operative when software instructions are executed.

### 7. Digital Processing System

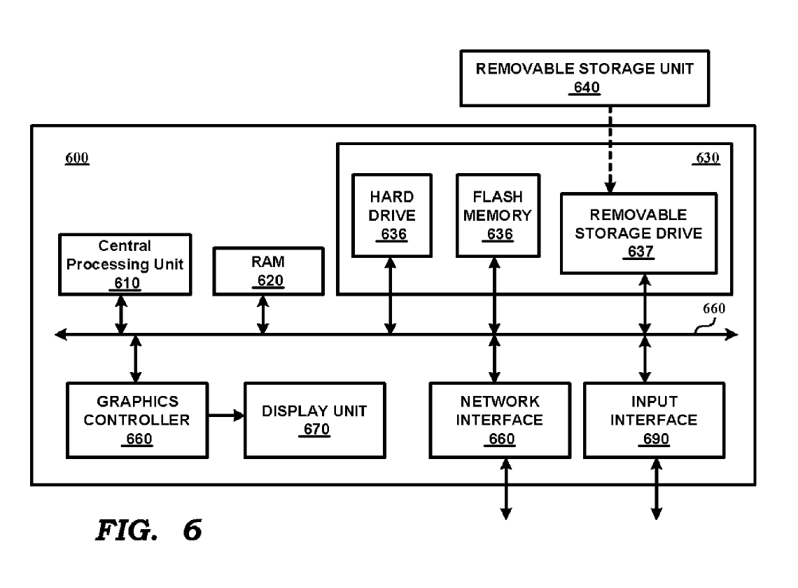

FIG. 6 is a block diagram illustrating the details of digital processing system 600 (corresponding to sender system 150) in which various aspects of the present invention are operative by execution of appropriate software instructions. Digital processing system 600 may contain one or more processors such as central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single general purpose-processing unit. RAM 620 may receive instructions from secondary memory 630 using communication path 650. RAM 620 may also be used by transport layer 155 for buffering the transport payloads.

Graphics controller 660 generates display signals (e.g., in RGB format) to display unit 670 based on data/instructions received from CPU 610. Display unit 670 contains a display screen to display the images defined by the display signals. Input interface 690 may correspond to a key-board and/or mouse. Network interface 680 provides connectivity to a network (e.g., network 110 using Internet Protocol), and may be used to communicate with other external systems (e.g., receiver system 140), for example to send data (and receive receipt confirmations) generated by sender application 152.

Secondary memory 630 may contain hard drive 635; flash memory 636 and removable storage drive 637. Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable storage medium having stored therein computer software and/or data.

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present invention described above.

### 9. CONCLUSION

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. Also, the various aspects, features, components and/or embodiments of the present invention described above may be embodied singly or in any combination in a data storage system such as a database system.

What is claimed is:

1. A method of estimating bandwidth of an underlying connection-oriented transport connection from a higher layer in a sender system, said transport connection being provided between said sender system and a receiver system, said method comprising:
sending a plurality of payloads over said underlying transport connection to said receiver system, each of said plurality of payloads being of different sizes;
receiving a plurality of indications from said receiver system, wherein each of said plurality of indications indicating that a corresponding one of said plurality of payloads is received by said receiver system;
calculating a plurality of times taken to transfer said plurality of payloads from said sender to said receiver over said underlying transport connection, each of said plurality of times corresponding to the transfer of a corresponding one of said plurality of payloads from said sender system to said receiver system; and
computing said bandwidth of said underlying transport connection based on said plurality of times.

2. The method of claim 1, wherein said transport connection is based on transport control protocol (TCP) and said TCP connection is supported on a Internet Protocol (IP) network.

3. The method of claim 1, wherein said computing comprises setting said bandwidth of said underlying transport connection to be directly proportionate to a window size of said underlying transport connection at said sender system, said method further comprises:
identifying a first payload with a first transfer time and a second payload with a second transfer time, wherein said first transfer time is within one network round-trip time of the said transport connection, and wherein said second transfer time approximately equals twice said first transfer time, wherein said first payload and said second payload are contained in said plurality of payloads; and
determining that said window size is between a size of said first payload and a size of said second payload.

4. The method of claim 3, wherein said identifying comprises sending a second plurality of payloads of said size of said first payload, determining payload of least transfer time as said first payload.

5. The method of claim 3, further comprising performing a search between said size of said first payload and said size of said second payload to determine said window size.

6. The method of claim 5, wherein said search comprises a binary search.

7. The method of claim 3, wherein said identifying comprises:
(a) sending a small payload;
(b) measuring a transfer time for said small payload; and
(c) iteratively performing said sending with larger payload and performing said measuring until said first transfer time and said second transfer time are obtained.

8. The method of claim 7, wherein (c) comprises setting size of said larger payload to twice size of said small payload.

9. The method of claim 3, wherein said computing comprises setting said bandwidth of said underlying transport connection to be inversely proportionate to a transfer time to transfer a payload of small size smaller than the maximum segment size (MSS) of said underlying transport connection.

10. The method of claim 3, wherein said computing comprises setting said bandwidth of said underlying transport connection to be proportionate to a congestion factor of said underlying transport connection wherein said congestion factor has a first value if said bandwidth is limited by available bandwidth on said underlying network and a second value if said bandwidth is limited by a window size in said receiver, wherein said first value is not equal to said second value.

11. The method of claim 10, wherein said first value is less than said second value.

12. The method of claim 10, further comprising:
sending a test payload of size equaling at least a factor times said window size of said underlying transport connection over said underlying transport connection, wherein said factor is greater than one;
calculating a test time required to transfer said test payload from said sender to said receiver over said underlying transport connection; and
determining that said bandwidth is limited by available bandwidth on said underlying network if said test time is greater by more than said factor times said transfer time to transfer a payload of size equaling said window size, and determining that said bandwidth is limited by said resources on said receiver otherwise.

13. The method of claim 1, wherein said transfer time of a payload is measured as a round-trip time to send said payload and receive indication at said sender that said payload is received at said receiver system.

14. An article of manufacture to estimate bandwidth of an underlying transport connection from a higher layer in a sender system, said transport connection being provided between said sender system and a receiver system, wherein execution of said one or more sequences of instructions by one or more processors contained in said system causes said one or more processors to perform the actions of:
sending a plurality of payloads over said underlying transport connection to said receiver system, each of said plurality of payloads being of different sizes;
receiving a plurality of indications from said receiver system, wherein each of said plurality of indications indicating that a corresponding one of said plurality of payloads is received by said receiver system;
calculating a plurality of times taken to transfer said plurality of payloads from said sender to said receiver over said underlying transport connection, each of said plurality of times corresponding to the transfer of a corresponding one of said plurality of payloads from said sender system to said receiver system; and
computing said bandwidth of said underlying transport connection based on said plurality of times.

15. The computer readable medium of claim 14, wherein said computing comprises setting said bandwidth of said underlying transport connection to be directly proportionate to a window size of said underlying transport connection at said sender system, further comprises:
identifying a first payload with a first transfer time and a second payload with a second transfer time, wherein said first transfer time is within one network round-trip time of the said transport connection, and wherein said second transfer time approximately equals twice said first transfer time, wherein said first payload and said second payload are contained in said plurality of payloads; and
determining that said window size is between a size of said first payload and a size of said second payload.

16. The computer readable medium of claim 15, wherein said identifying comprises sending a second plurality of payloads of said size of said first payload, determining payload of least transfer time as said first payload.

17. The computer readable medium of claim 15, further comprising performing a search between said size of said first payload and said size of said second payload to determine said window size.

18. An article of manufacture to estimate bandwidth of an underlying transport connection from a higher layer in a sender system, said transport connection being provided between said sender system and a receiver system, said article of manufacture comprising:
means for sending a plurality of payloads over said underlying transport connection to said receiver system, each of said plurality of payloads being of different sizes;
means for receiving a plurality of indications from said receiver system, wherein each of said plurality of indications indicating that a corresponding one of said plurality of payloads is received by said receiver system;
means for calculating a plurality of times taken to transfer said plurality of payloads from said sender to said receiver over said underlying transport connection, each of said plurality of times corresponding to the transfer of a corresponding one of said plurality of payloads from said sender system to said receiver system; and
means for computing said bandwidth of said underlying transport connection based on said plurality of times.

19. The article of manufacture of claim 18, wherein said means for computing sets said bandwidth of said underlying transport connection to be directly proportionate to a window size of said underlying transport connection at said sender system, said article of manufacture further comprises:
means for identifying a first payload with a first transfer time and a second payload with a second transfer time, wherein said second transfer time approximately equals twice said first transfer time, wherein said first payload and said second payload are contained in said plurality of payloads; and
means for determining that said window size is between a size of said first payload and a size of said second payload.

20. The article of manufacture of claim 19, wherein said means for identifying sends a second plurality of payloads of said size of said first payload, and determines payload of least transfer time as said first payload.
